(19) United States
(12) Patent Application Publication
(10) Pub. No.: US 2012/0099393 A1
(43) Pub. Date: Apr. 26, 2012

(54) Additive Control System and Methods

(76) Inventors: Jill Portman, San Anselmo, CA (US); Gary Shinner, San Anselmo, CA (US)

(21) Appl. No.: 13/281,165

(22) Filed: Oct. 25, 2011

Related U.S. Application Data
(60) Provisional application No. 61/406,359, filed on Oct. 25, 2010.

(51) Int. Cl. B01F 15/02

(52) U.S. Cl. 366/182.1

(57) ABSTRACT

A system and methods by which a first substance may be added to or produce a desired effect in a second substance, where the substances can be maintained separately before mixing. More specifically, the present invention is directed to a system including at least two vessels such as an additive vessel and a receiving vessel. An additive vessel may be configured with active control elements or passive control elements and may be nested in the receiving vessel.

This application claims the benefit of U.S. Provisional Application No. 61/406,359 filed Oct. 25, 2010.

### FIELD OF THE INVENTION

The present invention relates generally to a system and methods by which at least two substances may be maintained separately and selectively mixed in a controlled manner. More specifically, the present invention is directed to a system and methods including at least two vessels, each of which is configured to retain a substance.

### BACKGROUND OF THE INVENTION

Many devices and methods permit two or more substances to be maintained separately and, as needed, combined to produce a different substance or effect. Such known devices and methods often include combination arrangements consisting of two containers structured to retain a solid substance or a liquid substance, one container of which is positioned within the other container. Many such known combination arrangements have disadvantages associated with them including that they are often complicated structures or have a configuration that is not easy to use.

One known combination container arrangement includes a lid and a cup. The lid is a complicated structure that includes a space within which a first substance is held. The lid may be positioned over a cup containing a second substance. There are a number of disadvantages with such lid/cup arrangements. The complicated structure of the lid increases the expense of manufacturing, increases the cost for consumers, and often decreases the circumstances in which the device may be easily used. Also, such a complicated lid is difficult to wash, sanitize, store, and reuse.

Other known combination container arrangements, while simple in design, often do not permit easy use. One such combination container arrangement includes a first container that is sized and shaped to be nested within a second larger container. To mix the contents of the containers, the consumer must remove the first container from the second container and pour its contents into the second larger container. Such an arrangement has a number of disadvantages. When the first container is nested within the second container in close proximity to the substance held within the second container, the first container may become partially or completely covered with the substance of the second container. When the substance from the second container comes into contact with the first container, the consumer must determine where to place the first container after mixing the substances to avoid soiling another surface.

A demand therefore exists for a system and methods that is of a simplified construction and that permits substances to be retained and maintained in a separated state yet are available to be mixed in a controlled fashion by a consumer as needed. The present invention satisfies the demand.

### SUMMARY OF THE INVENTION

For convenience of description, terms such as “above”, “below”, “upper”, “lower”, “outer”, “inner”, “horizontal”, and “vertical” are used to refer to the system and the components of the system in an orientation illustrated in the accompanying drawings. However, it will be understood that the embodiments of the invention described in this application advantageously can be used in a variety of orientations.

A system and methods according to the present invention permit the separate storage and selective mixing of a first substance and a second substance. Embodiments of the system include at least two vessels, each vessel preferably having a simplified construction that permits the separation of the substances to be maintained. In an embodiment of the system having two vessels, one vessel is termed the “receiving vessel” and the other vessel is termed the “additive vessel”. The receiving vessel and the additive vessel may be identified generally as a “vessel” in this application.

The receiving vessel and the additive vessel may be complimentarily structured so that the additive vessel may fit within and be supportively engaged by the receiving vessel. This position is termed a “nested position” for purposes of this application. An additive vessel in a nested position is termed a “nested additive vessel” for purposes of this application. In a nested position, the additive top wall of the additive vessel may be slightly above, generally adjacent to, or slightly below the receiving top wall.

Embodiments of a receiving vessel typically include a receiving wall having a receiving side wall, a receiving bottom wall, and a receiving top wall. A receiving side wall is joined to the receiving bottom wall along a receiving bottom edge and to the receiving top wall along a receiving top edge.

The walls of a receiving vessel are configured to permit the retention of at least one substance, which is termed a “receiving substance” in this application. The receiving substance includes any substance fit to be consumed by humans including a liquid substance, a semi-liquid substance, and a solid substance. The walls of a receiving vessel also are configured to receive an additive vessel and retain it in a nested position.

Embodiments of an additive vessel typically include an additive wall having an additive side wall, an additive bottom wall, and an additive top wall. In some embodiments, an additive side wall may be joined to the additive bottom wall along an additive bottom edge and to the additive top wall along an additive top edge. Other embodiments of an additive vessel may include an additive wall having an additive top wall and an additive bottom wall that may meet each other at an additive top edge.

The walls of an additive vessel are configured to retain at least one substance, termed an “additive substance” in this application. An additive substance includes any substance that, upon mixing, may affect the physical characteristics such as composition, taste, flavor, density, texture, color, or temperature of the receiving substance. An additive substance may be a flavoring, syrup, nutritional powder, granular substance, liquid substance, semi-liquid substance, or solid substance. The additive substance may differ from the receiving substance only in, for example, temperature, concentration, or other characteristic.

Generally, embodiments of the vessels are configured to permit storage of substances within the vessels. Embodiments of the vessels also may be configured to permit the controlled movement of the additive substance, which, in some embodiments, results in the release of the additive substance into the receiving vessel. Such vessels may include “passive control elements” or “active control elements”. Passive control elements typically do not require consumer intervention to control the movement of the additive substance, while active control elements typically require consumer intervention.

Embodiments of an additive vessel having one or more passive control elements are configured to permit passive movement or positioning the additive control substance, release of the additive control substance from the additive vessel, or producing a desired effect in the receiving substance. A passive control element in an additive bottom wall may include one or more surfaces in an additive bottom wall such as generally horizontal surfaces, generally vertical surfaces, generally linear surfaces, generally curved surfaces, or generally sloped surfaces. A generally horizontal surface in an additive bottom wall is approximately 180 degrees or parallel relative to a flat plane on which an additive vessel may be positioned. A generally vertical surface in an additive bottom wall is approximately 90 degrees or perpendicular relative to a flat plane on which an additive vessel may be positioned. A generally linear surface in an additive bottom wall is a substantially flat surface. A generally curved surface in an additive bottom wall is any non-linear surface including, for example, convex curved surfaces, concave curved surfaces. A sloped surface in an additive bottom wall includes a gradient relative to horizontal by which the position of an additive substance may be influenced. An additive substance may move toward a lower side and away from an upper side of a sloped surface on a gradient. In certain embodiments, the gradient of the surface is alterable to permit increased control of the position of the additive substance.

Embodiments of a passive control element may include one or more combination surfaces. For purposes of this application, a “combination surface” may be a generally horizontal linear surface, a generally vertical linear surface, a generally horizontal curved surface, a generally vertical curved surface, a generally sloped linear surface, or a generally sloped curved surface.

Each embodiment of a passive control element may include one or more of the above surfaces. Each embodiment of a passive control element may include one surface such as one generally horizontal surface, one generally horizontal curved surface, one generally sloped linear surface, or one generally sloped curved surface, to name a few. Each embodiment of a passive control element also may include multiple surfaces such as a generally vertical surface and multiple generally horizontal surfaces, a generally vertical surface and multiple generally sloped surfaces, multiple generally horizontal surfaces and multiple generally vertical surfaces, multiple generally horizontal curved surfaces and multiple generally sloped surfaces, or multiple generally horizontal linear surfaces and multiple generally vertical curved surfaces, to name a few.

Various surfaces of the passive control element may be configured to form a compartment. For purposes of this application, a “compartment” is a space which may be defined by various surfaces in the additive bottom element, by the additive side wall and various surfaces in the additive bottom element, by the additive side wall, additive top wall, and various surfaces in the additive bottom element, or by the additive side wall, various surfaces in the additive bottom element, and a closure component. A compartment is sized, shaped, and designed to maintain an additive substance in a selected portion of the additive vessel. In certain embodiments, the compartment completely encloses or partially encloses the additive substance. Certain embodiments of a compartment permit the separate storage of more than one additive substance in the additive vessel at the same time.

Certain embodiments of a compartment are positioned relative to an outlet of the additive vessel such that an additive substance stored in the compartment does or does not contact an outlet when the additive vessel is in a particular orientation. Certain embodiments of a compartment are positioned relative to the expected position of the receiving substance when the additive vessel is in a nested position. In such embodiments, the compartment may be configured to be immersed in or may be configured not to be immersed in the receiving substance.

Embodiments of an additive vessel also may include one or more active control elements. An active control element may include weakenings such as scorings formed in or perforations or incisions cut through the flexible material sheet from which an additive wall may be made. In certain embodiments, an incision may define an outlet through which an additive substance may be released. A perforation may form a closed area which may be easily opened. In other embodiments, a weakening may be material that is relatively thin, and accordingly, more easily opened than the surrounding area. For purposes of this application, a weakening and surrounding area of the weakening positioned in an additive vessel is termed an “additive patterned area”.

In certain embodiments of an additive vessel, one or more additive patterned areas may be positioned to permit the controlled mixing or the treatment of one substance relative to the other substance. In certain embodiments, an additive patterned area is formed in an additive bottom wall, additive side wall, an additive top wall, or elsewhere in the additive vessel wall. An additive patterned area in an additive bottom wall may be configured to permit the release of additive substance out of the additive vessel. An additive patterned area in an additive top wall may be configured to permit access to the additive vessel.

In certain embodiments, a portion or entirety of an additive patterned area is openable to form an outlet. An additive patterned area may be opened by the application of pressure at or near its weakenings. When the additive patterned area is in an open state, the outlet permits the release of additive substance from the additive vessel. An additive patterned area also may be closable such that, in the resulting closed state, the additive vessel does not permit or decreases the release of the additive substance. When the additive vessel is in the nested position, an openable additive patterned area permits the controlled mixing or the controlled treatment of the substances.

Certain embodiments of the present invention include a closure component. A closure component may be configured to cover whatever portions of the additive inner volume are not enclosed by the additive wall. A closure component also may be configured to cover whatever portions of the receiving inner volume are not enclosed by the receiving wall and nested additive vessel. In addition, a closure component may be configured to prevent foreign objects from entering and prevent spillage from exiting the vessels. Embodiments of a closure component may include, for example, an overflow trough, an aperture for drinking, an egress element for pouring, or a patterned area. A patterned area formed in a closure component is termed a “closure patterned area” in this application.

A closure component may be configured to meet with, seal, or attach to one or both vessels. In certain embodiments, the closure component is configured to attach only to the additive vessel, which, when in a nested position, may cover the receiving inner volume of the receiving vessel. In certain embodiments, a closure component is sized and shaped to attach to either vessel or both vessels simultaneously.

Embodiments of a closure component configured to attach to a vessel include an attachment element. Embodiments of an attachment element may include, for example, adhesive, fastener, sealant, hook and loop components, screw threading, overwrapping, enclosure element, lock, button, tack, clip, pin, clasp, bolt, buckle, male closure components paired with female closure component, complementary components, vessel securing arrangement including one or more nodes and a holding area, or any other configuration that will join the closure component to a vessel.

Embodiments of attachment elements may be configured to attach to any portion of the receiving wall including a receiving top wall, receiving side wall, and receiving bottom wall, or any portion of the additive wall including an additive top wall, and additive side wall, and additive bottom wall. In certain embodiments, the closure component includes a tamper-evident seal, which includes some indicator of tampering such as a broken adhesive.

One advantage of the present invention is the system and methods permit two substances to be maintained in a separated state in a single system.

Another advantage of the present invention is that the system and methods permit easy mixture of two substances in a controlled manner and on an as needed basis.

Another advantage of the present invention is that the system and methods permit a consumer to prepare or treat a receiving substance according to the taste of the consumer.

Another advantage of the present invention is that the substances maintained in a separated state may be fresher or less diluted as a result of remaining separate.

Another advantage of embodiments of the present invention is that the system and methods permit mixture by simply applying pressure to the additive patterned area.

Another advantage of embodiments of the present invention is that the system and methods permit complete enclosure of the additive substance and the receiving substance with a closure component.

Another advantage of embodiments of the present invention is that the system and methods permit a consumer to select which substances are stored in an additive vessel and in a receiving vessel.

Another advantage of embodiments of the present invention is that the system and methods permit a consumer to reuse and refill the receiving vessel and the additive vessel with selected substances.

Another advantage of embodiments of the present invention is that the system and methods permit a consumer to access the additive substance and the receiving substance contemporaneously.

Another advantage of embodiments of the present invention is that a consumer may obtain all of the components for a mixture in a single system.

Another advantage of the present invention is that a consumer easily may move from one location to another with all of the components for a mixture.

Another advantage of embodiments of the present invention is that the system permits a consumer to securely grip the receiving vessel.

Another advantage of embodiments of the present invention is that the size and shape of the closure component reduces spillage.

Another advantage of embodiments of the present invention is that a closure component positioned on the vessels stabilizes the nested vessels.

Another advantage of embodiments of the present invention is that the system includes an additive patterned area that is openable and closable to permit controlled release of an additive substance form an additive vessel.

Another advantage of the present invention is that the system may be distributed easily and quickly such as from a vending machine or “to go” from an establishment.

An additional advantage of the present invention is that the system has a simplified construction that is easy to manufacture, store, and clean.

An additional advantage of embodiments of the present invention is that the system and methods reduce the time necessary to mix the substances.

An additional advantage of the present invention is that it permits a consumer to store an additive vessel within a receiving vessel such that during and after mixing, the additive vessel need not be removed from its nested position on the receiving vessel, therefore eliminating a need to handle or discard the additive vessel separate from the combined vessels.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will be described in conjunction with the appended drawings provided to illustrate and not to the limit the invention, where like designations denote like elements, and in which:

FIG. 1A is an exploded perspective view of an embodiment of the present invention including the additive vessel above and positioned to be received in a nested position within a receiving vessel;

FIG. 1B is a perspective view of an embodiment of the present invention including an additive vessel nested within a receiving vessel;

FIG. 1C is an exploded perspective view of an embodiment of the present invention including an additive vessel nested in a receiving vessel and a closure component;

FIG. 1D is a perspective view of an embodiment of the present invention including an additive vessel nested within a receiving vessel and a user access tool;

FIG. 2A is an exploded perspective view of an embodiment of the present invention including an additive vessel above and positioned to be received in a nested position within a receiving vessel;

FIG. 2B is a perspective view of an embodiment of the present invention including an additive vessel nested within a receiving vessel;

FIG. 2C is an exploded perspective view of an embodiment of the present invention including an additive vessel nested in a receiving vessel and a closure component;

FIG. 3 is an exploded perspective view of an embodiment of the present invention including a closure component, an additive vessel, and a receiving vessel;

FIG. 4 is an exploded perspective view of an embodiment of the present invention including an additive vessel nested in a receiving vessel and a closure component;

FIG. 5 is a perspective view of an embodiment of the present invention including an additive vessel nested within a receiving vessel;

FIG. 6A is a perspective view of an embodiment of the present invention including an additive vessel nested in a receiving vessel and a closure component;

FIG. 6B is a top view of an embodiment of the present invention according to FIG. 6A not including the closure component;

FIG. 7A is a perspective view of an embodiment of the present invention including a closure component and an additive vessel nested within a receiving vessel;

FIG. 7B is a top view of an embodiment of the present invention according to FIG. 7A including the closure component;

FIG. 8 is an exploded perspective view of an embodiment of the present invention including a closure component and an additive vessel;

FIG. 9A is an exploded perspective view of an embodiment of the present invention including an additive vessel positioned to be received in a nested position within a receiving vessel;

FIG. 9B is an exploded perspective view of an embodiment of the present invention including a closure component positioned to be received on an additive vessel nested within a receiving vessel;

FIG. 10A is an exploded perspective view of an embodiment of the present invention including an additive vessel positioned to be received in a nested position within a receiving vessel;

FIG. 10B is a perspective view of an embodiment of the present invention including an additive vessel nested within a receiving vessel;

FIG. 11A is an exploded perspective view of an embodiment of the present invention including an additive vessel positioned to be received in a nested position within a receiving vessel;

FIG. 11B is a perspective view of an embodiment of the present invention including the additive vessel nested within the receiving vessel;

FIG. 12A is an exploded perspective view of an embodiment of the present invention including an additive vessel positioned to be received in a nested position within a receiving vessel;

FIG. 12B is a perspective view of an embodiment of the present invention including the additive vessel nested within a receiving vessel;

FIG. 13A is an exploded perspective view of an embodiment of the present invention including an additive vessel positioned to be received in a nested position within a receiving vessel;

FIG. 13B is a perspective view of an embodiment of the present invention including the additive vessel nested within a receiving vessel;

FIG. 14A is an exploded perspective view of an embodiment of the present invention including an additive vessel positioned to be received in a nested position within a receiving vessel;

FIG. 14B is a perspective view of an embodiment of the present invention including the additive vessel nested within a receiving vessel;

FIG. 14C is an exploded perspective view of an embodiment of the present invention including an additive vessel nested in a receiving vessel and a closure component;

FIG. 14D is a top view of an embodiment of the additive vessel with the additive patterned area in a closed state;

FIG. 14E is a top view of an embodiment of an additive vessel with the additive patterned area in an open state; and

FIG. 14F is a top view of an embodiment of a closure component.

While the invention is susceptible to various modifications and alternative forms, specific exemplary embodiments thereof have been shown by way of example in the drawings and have herein been described in detail. It should be understood, however, that there is no intent to limit the invention to the particular embodiments disclosed, but on the contrary, the intention is to cover all modifications, equivalents, and alternatives falling within the scope of the invention as defined by the appended claims.

### DESCRIPTION OF PREFERRED EMBODIMENTS

Embodiments of a system 25 include at least two vessels—an additive vessel 31 and a receiving vessel 71. Certain embodiments of the present invention may include more than one additive vessel 31 such as a first additive vessel and a second additive vessel. Certain embodiments of the present invention may include more than one receiving vessel 71 such as a first receiving vessel and a second receiving vessel.

Embodiments of an additive vessel 31 typically include an additive wall 33 configured to retain or contain an additive substance 22. An additive wall 33 may include an additive side wall 35, an additive bottom wall 37, and an additive top wall 34. Embodiments of an additive side wall 35 may include a generally vertical additive side wall. The additive side wall 35 may be joined to the additive bottom wall 37 along an additive bottom edge 36 and to the additive top wall 34 along an additive top edge 38. Other embodiments of an additive vessel 31 may include an additive wall 33 having an additive top wall 34 and an additive bottom wall 37 that are joined at an additive top edge 38.

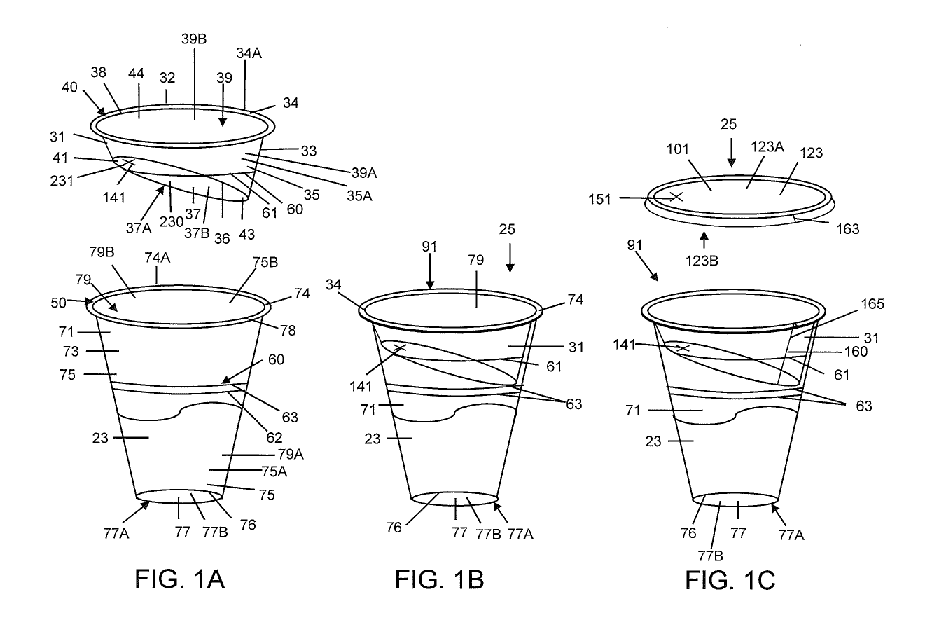

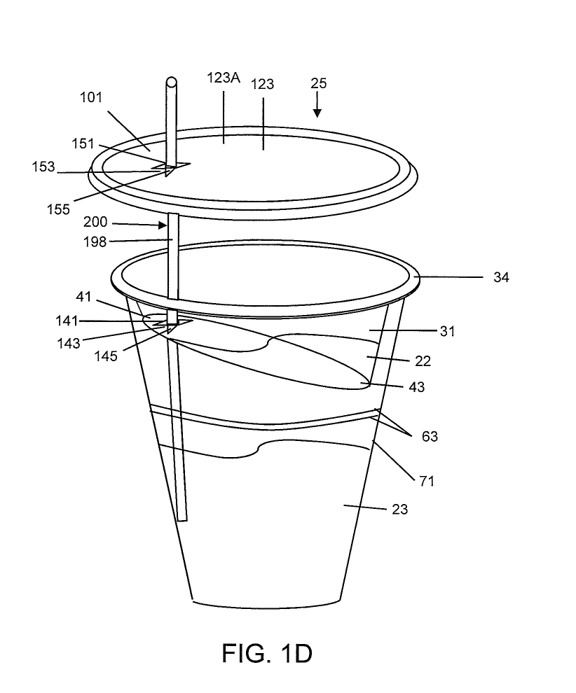

As illustrated in FIG. 1A, an additive side wall 35 may include an additive side outer surface 35A and an additive side inner surface 35B. The additive bottom wall 37 includes an additive bottom outer surface 37A and an additive bottom inner surface 37B. The additive top wall 34 may include an additive top surface 34A and an additive bottom surface 34B. The additive side outer surface 35A and the additive bottom outer surface 37A define an additive outer surface 39A. The additive side inner surface 35B and the additive bottom inner surface 37B form an additive inner surface 39B, which defines an additive inner volume 39 that is preferably configured to retain an additive substance 22.

In certain embodiments, an additive wall 33 configured to be received by a receiving wall 73 may include enlarged sections. An enlarged section of an additive wall 33 may form an additive support element 40, which may be configured to interact with the receiving wall 73 when in a nested position 91. An additive support element 40 may include, for example, an additive side support element 47 formed from the additive side wall 35 or an additive top support element 45 formed from the additive top wall 34.

Embodiments of a receiving vessel 71 typically include a receiving wall 73 configured to retain a receiving substance 23. A receiving wall 73 may include a receiving side wall 75, a receiving bottom wall 77, and a receiving top wall 74. Embodiments of a receiving side wall 75 may include a generally vertical receiving side wall. The receiving side wall 75 may be joined to the receiving bottom wall 77 along a receiving bottom edge 76 and to the receiving top wall 74 along a receiving top edge 78.

As shown in FIG. 1A, the receiving side wall 75 may include a receiving side outer surface 75A and a receiving side inner surface 75B. The receiving bottom wall 77 includes a receiving bottom outer surface 77A and a receiving bottom inner surface 77B. The receiving top wall 74 may include a receiving top surface 74A and a receiving bottom surface 74B. The receiving side outer surface 75A and the receiving bottom outer surface 77A define a receiving outer surface 79A. Collectively, the receiving side inner surface 75B and the receiving bottom inner surface 77B form a receiving inner surface 79B that defines an receiving inner volume 79 having a complementary configuration and dimension such that the additive vessel 31 may be received and held in a nested position 91. Additionally, the receiving inner volume 79 may be configured to retain a receiving substance 23.

In certain embodiments, a receiving wall 73 may include a receiving support element 50 by which an additive vessel 31 may be supported when in a nested position 91. A receiving support element 50 may include, for example, a receiving side support element 57 formed from the receiving side wall 75 or a receiving top support element 59 formed from the receiving top wall 74.

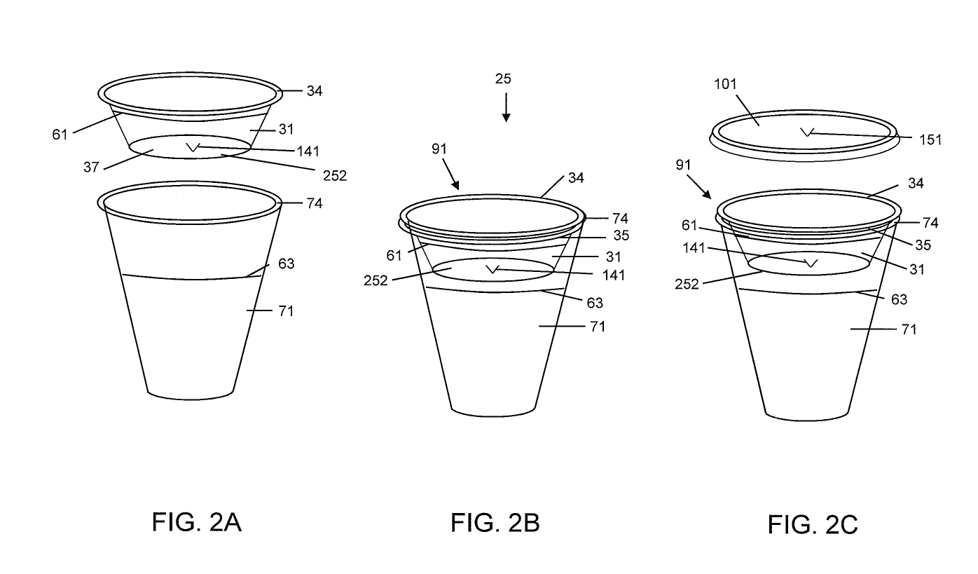

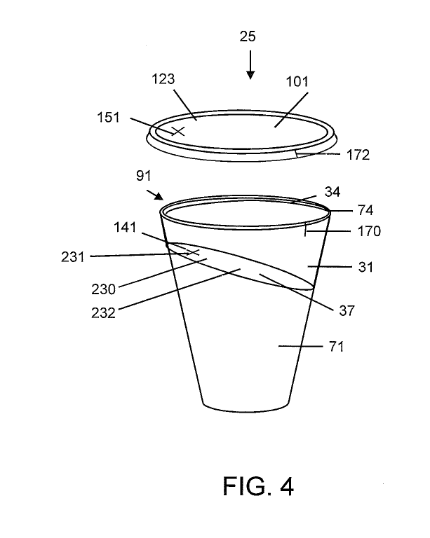

The vessels 31, 71 may be sized and shaped such that, when in a nested position 91, the additive top wall 34 of the additive vessel 31 is generally adjacent to, slightly below, or slightly above the receiving top wall 74 of the receiving vessel 71. Certain embodiments, such as the embodiment illustrated in FIG. 1B-FIG. 1D, include an additive top wall 34 that is generally adjacent to the receiving top wall 74. Certain embodiments, such as the embodiment illustrated in FIG. 4, include an additive top wall 34 positioned slightly below the receiving top wall 74. Certain embodiments, such as the embodiment illustrated in FIG. 2B-FIG. 2C, include an additive top wall 34 positioned slightly above the receiving top wall 74.

As shown in FIG. 1A-FIG. 1C, vessel walls 33, 73 may include one or more fill lines 60. Fill lines 60 are configured and positioned to permit a consumer to measure a volume of additive substance 22 or receiving substance 23 by achieving a level that is even with a fill line 60. A fill line 60 may include, for example, a demarcation on the vessel wall 33, 73, an irregular texture in the vessel wall 33, 73, an indent in the vessel wall 33, 73, or a change in circumference in the vessel wall 33, 73. A fill line 60 may be used to avoid overflowing a receiving vessel 71 when the additive vessel 31 is put in a nested position 91. Additionally, a consumer may use a fill line 60 to measure a desired level of additive substance 22 such that control over release of additive substance 22 out of the additive vessel 31 may be maintained. A fill line 60 in an additive wall 33 is termed an additive fill line 61, and a fill line 60 in a receiving wall 73 is termed a receiving fill line 63 for purposes of this application.

Certain embodiments of additive vessels 31 include control elements such as passive control elements 230 or active control elements 231. Control elements generally permit the consumer to have improved control over the movement of the additive substance 22. Passive control elements 230 typically do not require consumer intervention to control movement if the additive substance, while active control elements 231 typically require consumer intervention.

Embodiments of passive control elements 230 include an additive bottom wall 37 configured with one or more generally sloped surfaces 232, curved surfaces 240, horizontal surfaces 252, vertical surfaces 255, or any combination of these surfaces. Each surface 232, 240, 252, 255 may be configured individually or in combination to permit the controlled release of the additive substance 22. Certain surfaces may be configured to form a funnel 222 to promote movement of an additive substance 22 or may form a compartment 182 in which an additive substance 22 is retained. The embodiment of an additive vessel 31 shown in FIG. 1A-FIG. 1D includes an additive bottom wall 37 configured with a passive control element 230 in the form of a sloped surface 232. The sloped surface 232 in FIG. 1A-FIG. 1D includes a gradient angled relative to horizontal to form an upper side 41 and a lower side 43 of the surface 232. Additional embodiments of passive control elements 230 will be identified throughout this application.

A preferred embodiment of an active control element 231 is an additive patterned area 141, which includes weakenings such as scorings formed in or perforations or incisions cut through the flexible material sheet from which an additive wall 33 may be made. Additive patterned areas 141 may be opened by the application of pressure at the additive patterned area 141. Such pressure may be applied, for example, by a finger or a user access tool 198 such as shown in FIG. 1D. A user access tool 198 is a tool configured to permit a user to access the additive inner volume 39 of an additive vessel 31. In certain embodiments, a user access tool 198 may include, for example, a straw 200, a dowel, a rod having a point-tip, or a utensil 185, to name a few.

The insertion of a straw 200 into the additive patterned area 141 of this embodiment exposes the opposing edges 143 and open sections 145 which separate the opposing edges 143. The additive patterned area 141 and resulting open sections 145 are configured to permit controlled release of the additive substance 22 into the receiving vessel 71 below.

Embodiments of the system 25 also may include a closure component 101 configured to allow the additive vessel 31 and the receiving vessel 71 to be covered and maintained in an easy to use configuration relative to each other. Embodiments of a closure component 101 may include a wall that meets with or connects with one or both of the vessels 31, 71 to prevent foreign objects from entering and prevent spillage from exiting. Embodiments of a closure component 101 also may include an aperture for drinking, an egress element, or a closure patterned area 151.

The embodiment of a closure component 101 shown in FIG. 1C-FIG. 1D is configured as a cover 123. A cover 123 may have an upper cover surface 123A and a lower cover surface 123B. The lower cover surface 123B may include a structure or adhesive by which the cover 123 may be maintained in a releasably fixed position on the additive top wall 34.

The embodiment of a cover 123 shown in FIG. 1C-FIG. 1D is additionally comprised of a closure patterned area 151. Certain closure patterned areas 151, including the one shown in FIG. 1C and FIG. 1D, are configured to be aligned with an additive patterned area 141. Upon aligning the patterned areas 141, 151, a user access tool 198 such as a straw 200 may pass through both the closure patterned area 151 and the additive patterned areas 141. The insertion of a straw 200 into the closure patterned area 151 of this embodiment exposes the closure opposing edges 153 and closure open sections 155.

In certain embodiments, alignment of patterned areas 141, 151 may be facilitated by an alignment component 160. An alignment component 160, which may be positioned on a closure component 101, an additive vessel 31, or both a closure component 101 and an additive vessel 31, is configured to permit a consumer to achieve a particular alignment of the closure component 101 with respect to the additive vessel 31. Alignment components 160 may include one or more complementary components that may be matched up or snap into each other. As shown in FIG. 1C, the alignment component 160 may be a first alignment mark 163 on a cover 123 and a second alignment mark 165 on an additive vessel 31. Additional embodiments of alignment components 160 are identified throughout this application.

As shown in FIG. 1 D, the additive substance 22 may be retained within the additive vessel 31 until mixing of the substances 22, 23 is desired. At that time, an additive patterned area 141 and closure patterned area 151 may be opened to permit some or all of the additive substance 22 to be released from the additive vessel and received in the receiving vessel 71.

Another embodiment of the system 25, as shown in FIG. 2A-FIG. 2C, is configured such that an additive substance 22 may be added to or produce a desired effect in a receiving substance 23. The embodiment of an additive vessel 31 shown in FIG. 2A-FIG. 2C includes an additive bottom wall 37 configured with a generally horizontal surface 252 and an additive patterned area 141. FIG. 2C includes a cover 123 that may be positioned on the additive vessel 31 or the receiving vessel 71.

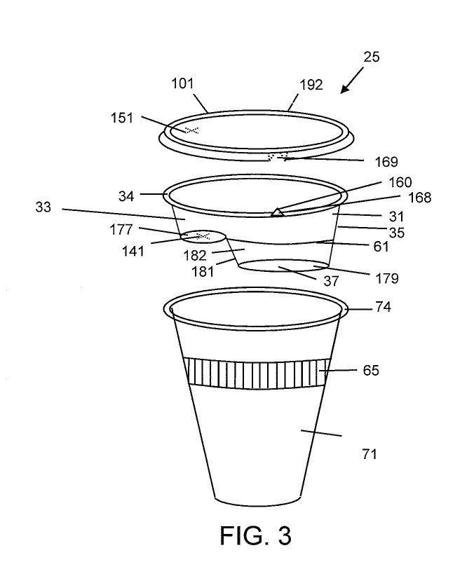

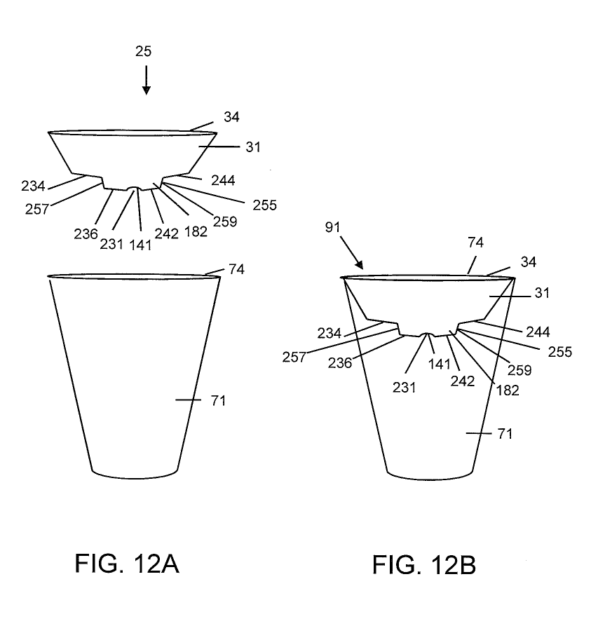

Embodiments of an additive vessel 31 also may include an additive bottom wall 37 configured with surfaces forming one or more compartments 182. Embodiments in FIG. 3, FIG. 12A, and FIG. 12B each include an additive bottom wall 37 configured with a compartment 182 and an additive patterned area 141.

In the embodiment shown in FIG. 3, the additive bottom wall 37 is formed from a first horizontal surface 177, a second horizontal surface 179, and a first vertical surface 181. The compartment 182 is formed by the first vertical surface 181, the second horizontal surface 179, and the generally vertical additive side wall 35. In this embodiment, an additive substance 22 stored in the compartment 182 below the additive fill line 61 advantageously is not exposed to the additive patterned area 141 unless the orientation of the additive vessel 31 is changed.

Certain embodiments of the receiving vessel 71, including the embodiment illustrated in FIG. 4, include a generally vertical receiving side wall 75 having a gripping component 65. A gripping component 65 is an irregular surface portion of the receiving side wall 75 configured to improve traction and permit a consumer to grip the receiving side wall 75 more easily.

The embodiment shown in FIG. 3 also includes a closure component 101 having a closure patterned area 151 and an alignment component 160 configured as a male alignment component 168 and a female alignment component 169. A male alignment component 168 and a female alignment component 169 may be configured such that if a consumer attempted to bring the closure component 101 together with the additive vessel 31 in any orientation other than the desired alignment, the connection would be disrupted by the male alignment component 168. In the desired position, the female alignment component 169 is receives the male alignment component 168.

FIG. 4 illustrates another embodiment of the system 25 configured such that an additive substance 22 may be added to or produce a desired effect in a receiving substance 23. The embodiment shown in FIG. 4 includes an additive vessel 31 that is releasably fastenable to the receiving vessel 71. In addition, FIG. 4 shows a cover 123 that may be positioned on the additive vessel 31 and the receiving vessel 71 simultaneously. In this embodiment, an additive patterned area 141 and closure patterned area 151 may be aligned by lining up a first alignment line 170 on the additive vessel 31 and a second alignment line 172 on the cover 123. The embodiment shown in FIG. 4 also includes an additive bottom wall 37 having a passive control element 230 in the form of a sloped surface 232.

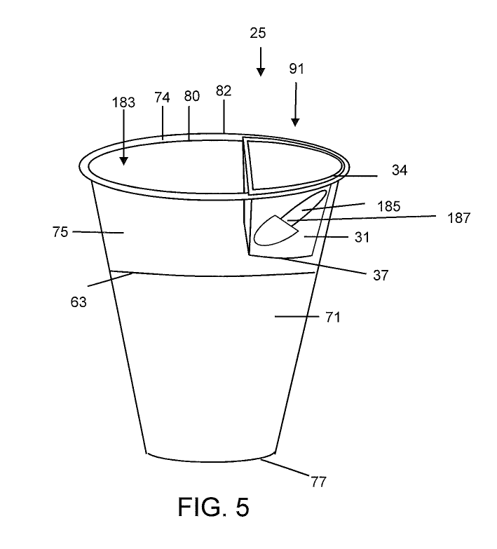

The embodiment of the system 25 shown in FIG. 5 includes an additive vessel 31 having no additive patterned area 141. Such an embodiment of an additive vessel 31 is configured to store items not intended to be added to a receiving substance 23. For example, a user access tool 198, a treatment such as ice or a hot substance, or a utensil 185 may be stored in the additive vessel 31. FIG. 5 shows a utensil 185 configured as a spoon 187 stored in the additive vessel 31.

In the embodiment of FIG. 5, a receiving top wall 74 includes an inner top edge 80 and an outer top edge 82. When the additive vessel 31 is in a nested position 91, an additive top wall 34 may be generally adjacent to the receiving top wall 74 and end between the inner top edge 80 and the outer top edge 82. In other embodiments, the additive top wall 34 ends near the inner top edge 80, ends near the outer top edge 82, or has another configuration.

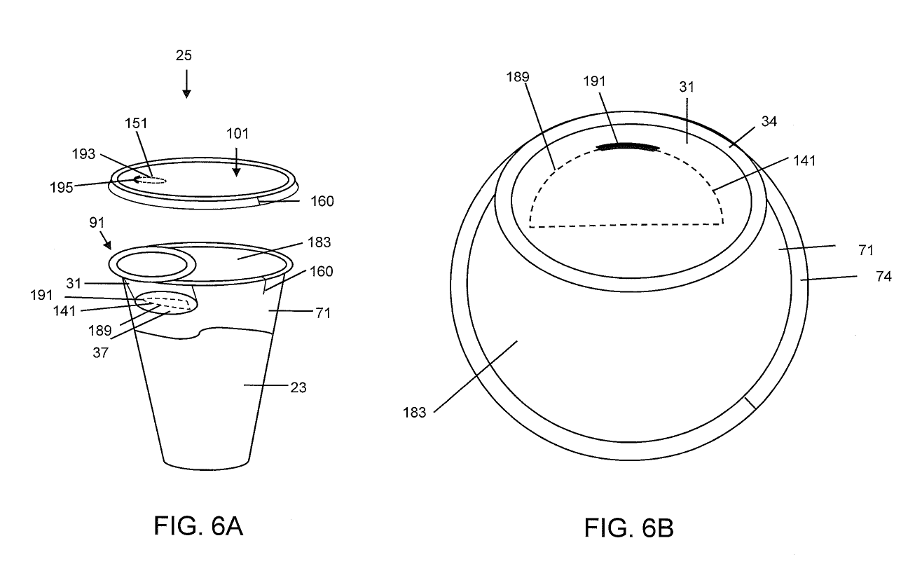

The embodiments shown in FIG. 5, FIG. 6A, and FIG. 6B include an additive vessel 31 sized and shaped such that when the additive vessel 31 is in a nested position 91, a receiving vessel access space 183 is formed. The receiving vessel access space 183 is configured such that a consumer is able to easily access the receiving substance 23 in the receiving vessel 71, for example, with a utensil 185.

The embodiment of FIG. 6A and FIG. 6B also include an additive patterned area 141 having a partially frangible border 189-that is, a border designed to be broken to permit an additive substance 22 to be released into the receiving vessel 71—and a partially non-frangible border 191—that is, a border designed not to break such that no portion of the additive bottom wall 37 falls into the receiving vessel 71. The embodiment shown in FIG. 6A and FIG. 6B further includes a closure patterned area 151 having an easily detachable border 193—that is, a border designed to be broken by a straw 200 or other user access tool 198—and a fixed border 195—that is, a border designed not to break such that no portion of the closure component 101 falls into the additive vessel 31.

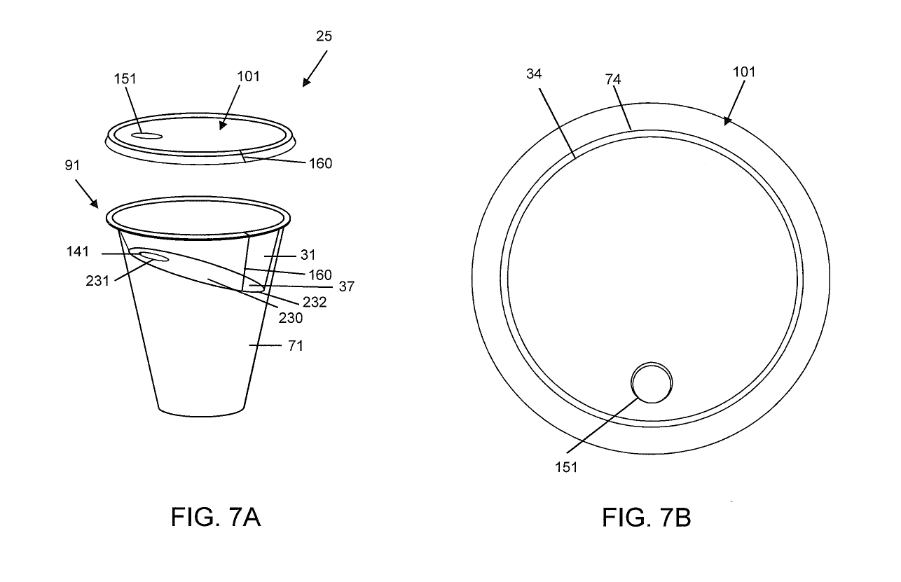

FIG. 7A and FIG. 7B illustrate another embodiment of the system 25 configured such that an additive substance 22 may be added to or produce a desired effect in a receiving substance 23. The embodiment shown in FIG. 7A and FIG. 7B includes an additive patterned area 141 and a closure patterned area 151 which may be aligned using alignment components 160.

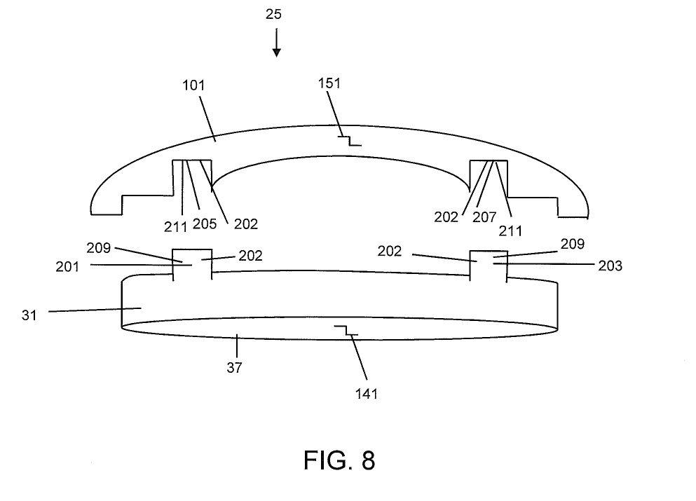

The embodiment of the present invention shown in FIG. 8 shows a closure component 101 and an additive vessel 31, each of which is sized and shaped to be fastened to the other via an attachment element 105 such as a fastener 202. A fastener 202 may include an adhesive, hook and loop components, a button, a clip, a slide, a clasp, male closure component and female closure component, or any other configuration that will releasably join the closure component 101 with the additive vessel 31.

The embodiment of an additive vessel 31 illustrated in FIG. 8 is configured with a first additive fastener 201 and a second additive fastener 203, and the embodiment of a closure component 101 is configured with a first closure fastener 205 and a second closure fastener 207. In this embodiment, the first and second additive fasteners 201, 203 are configured as male closure components 209 that are complementary to and may fasten to the first and second closure fasteners 205, 207 which are configured as female closure components 211.

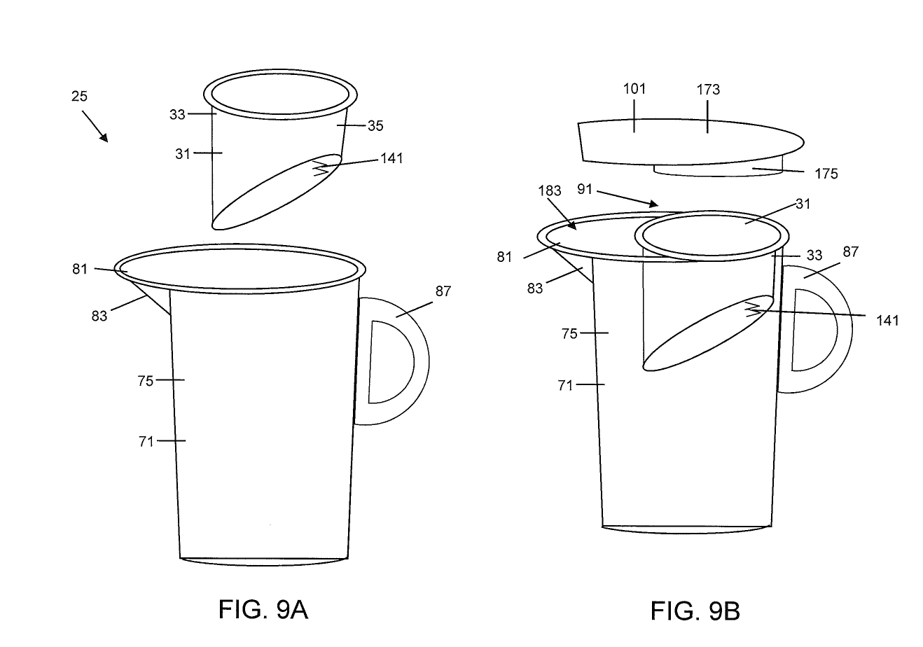

FIG. 9A and FIG. 9B illustrate another embodiment of the system 25 configured such that an additive substance 22 may be added to or produce a desired effect in a receiving substance 23. The receiving side wall 75 of the receiving vessel 71 of this embodiment includes a handle 87 and a receiving spout 83. A receiving spout 83 defines an egress element 81, by which a receiving substance 23 may be poured out or otherwise removed from the receiving vessel 71. The embodiment of an additive vessel 31 illustrated in FIG. 9A and FIG. 9B includes an additive patterned area 141.

The embodiment shown in FIG. 9B also includes a closure component 101 configured as a cap 173, which is sized and shaped to cover at least part of the receiving vessel 71 while the additive vessel 31 is in a nested position 91. The cap 173 also is sized and shaped to permit pouring or dispensing of the receiving substance 23 through the egress element 81 while the cap 173 is in covering the receiving vessel 71. As shown in FIG. 9B, a cap 173 may be comprised of a gasket 175 configured to stabilize an additive vessel 31 during pouring or moving of the receiving vessel 71. In this embodiment, the gasket 175 is sized and shaped to fill a portion of the space defined by the additive inner volume 39.

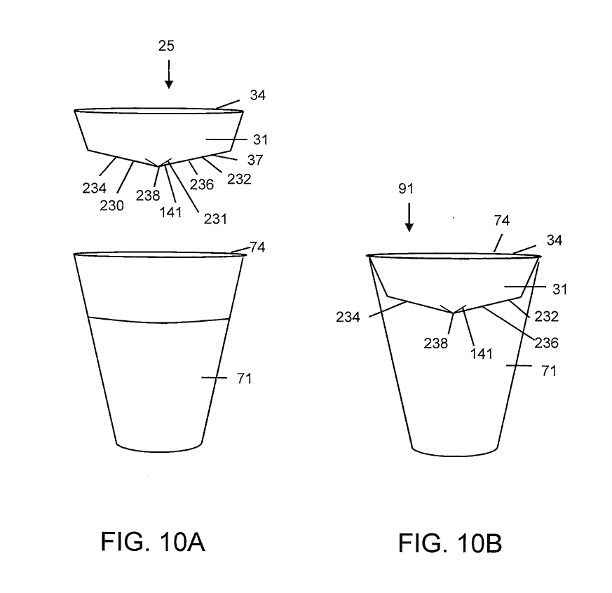

FIG. 10A and FIG. 10B illustrate an embodiment of the system 25 which include sloped surfaces 232 in the additive bottom wall 37. A first sloped surface 234 and a second sloped surface 236 meet at a meeting point 238. The embodiment of an additive vessel 31 shown in FIG. 10A and FIG. 10B also includes an additive patterned area 141 positioned at or near the meeting point 238 to promote the release of the additive substance 22.

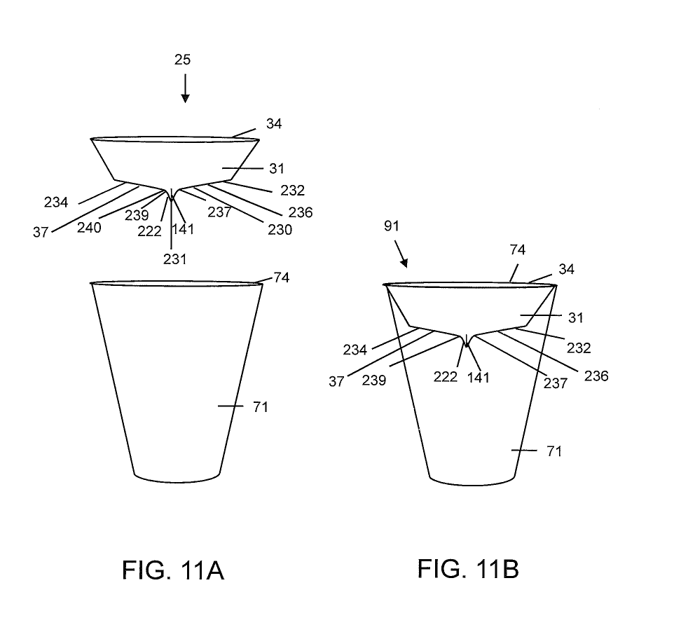

FIG. 11A and FIG. 11B illustrate another embodiment of the system 25 which includes an additive patterned area 141, sloped surfaces 232, and curved surfaces 240 in the additive bottom wall 37. In FIG. 11A and FIG. 11B, the additive bottom wall 37 includes a first sloped surface 234, a second sloped surface 236, a first curved surface 237, and a second curved surface 239. The combination of surfaces in the additive bottom wall 37 of this embodiment form a funnel 222 configured to permit the additive substance 22 to move in a controlled manner towards the additive patterned area 141 positioned at or near the bottommost point of the funnel 222.

The embodiment shown in FIG. 12A and FIG. 12B includes an additive vessel 31 having sloped surfaces 232 and generally vertical surfaces 255 which form a compartment 182. Specifically, the embodiment illustrated in FIG. 12A and FIG. 12B includes a first sloped surface 234, a second sloped surface 236, a third sloped surface 242, a fourth sloped surface 244, a first vertical surface 257, and a second vertical surface 259. In this embodiment, the additive patterned area is positioned at the lowest point in the compartment 182 to increase release of an additive substance 22.

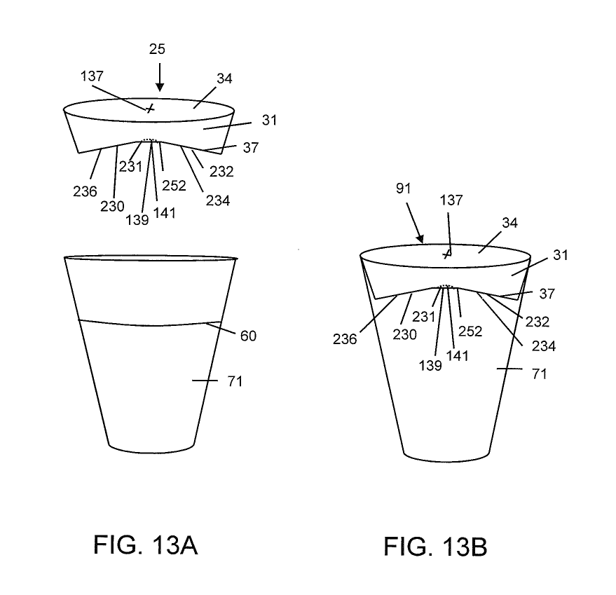

FIG. 13A and FIG. 13B illustrate another embodiment of the system 25 in which an additive bottom wall 37 includes an additive patterned area 141, sloped surfaces 232 and a generally horizontal surface 252, each positioned to permit controlled release of an additive substance 22. Specifically, the additive bottom wall 37 is formed by a first sloped surface 234, a second sloped surface 236, and a generally horizontal surface 252.

In certain embodiments of the present invention, an additive top wall 34 may be configured to permit access to the additive inner volume 39 of the additive vessel 31. In such embodiments, the additive top edge 38 may define an additive vessel access space 44, as illustrated in FIG. 1A-FIG. 1D. In other embodiments, an additive top wall 34 is configured to be continuous such that, together with the additive side wall 35 and the additive bottom wall 37, the additive wall 33 encloses the additive inner volume 39, as illustrated in FIG. 13A and FIG. 13B. In the latter embodiment, an additive patterned area 141 may be positioned in the additive top wall 34. The embodiment illustrated in FIG. 13A and FIG. 13B includes a first additive patterned area 137 positioned in an additive top wall 34 and a second additive patterned area 139 positioned in the additive bottom wall 37.

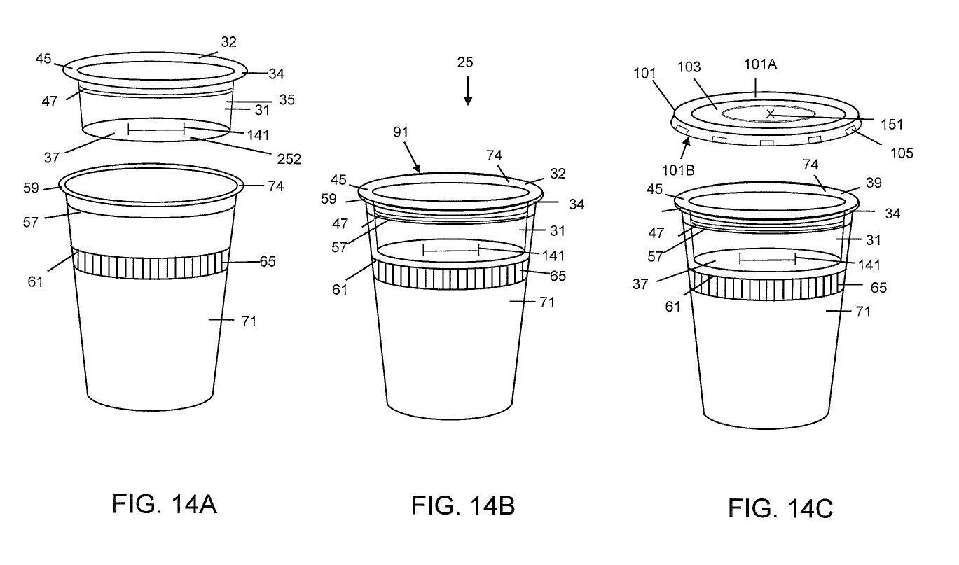

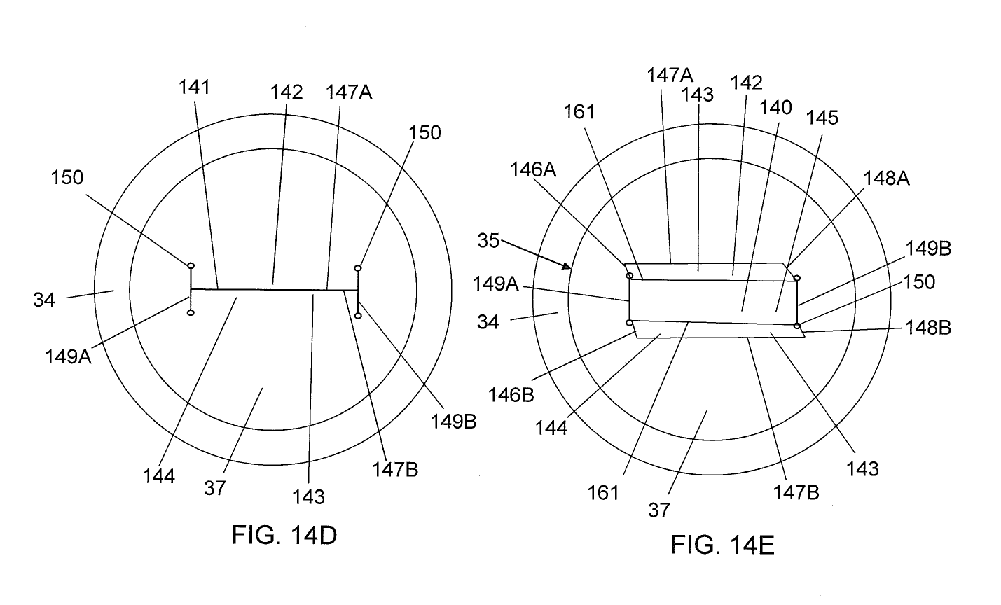

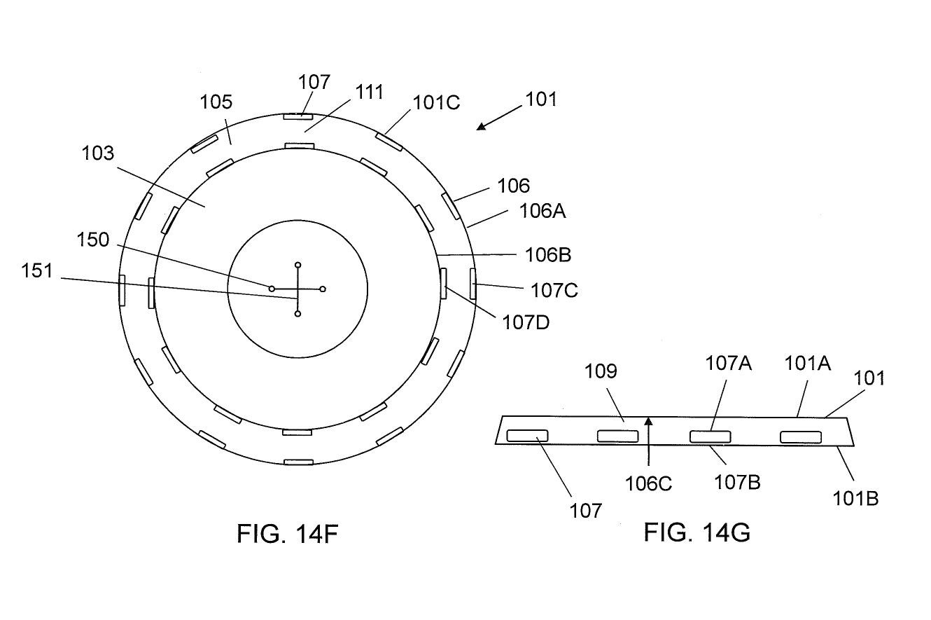

Embodiments of an additive vessel 31 may include an enlarged additive top wall 32. As illustrated in FIG. 14A and FIG. 14B, an enlarged additive top wall 32 may form an additive top support element 45, which may be configured to support the additive vessel 31 on the receiving vessel 71 in a nested position 91. Embodiments of a receiving top wall 74 also may include receiving top support element 59 on which an additive top support element 45 may be supported when the vessels 31, 71 are in the nested position 91. A receiving side wall 75 also may include receiving side support element 57, which may support an additive side support element 47 when the vessels 31, 71 are in a nested position 91.

In certain embodiments, an additive patterned area 141 is configurable to provide a closed state, as shown in FIG. 14D, or an open state, as shown in FIG. 14E. In the closed state, the entirety of each opposing edge 143 is in contact with either another opposing edge 143 or another portion of the additive bottom wall 37 such as an additive bottom wall border 149. While in the open state, at least a portion of each opposing edge 143 is not in contact with another opposing edge 143 or another portion of the additive bottom wall 37. In the open state, the opposing edges 143 generally define one or more open sections 145. The open section 145 may form an outlet 140 through which an additive substance 22 may be released from the additive vessel 31.

When in an open state, the opposing edges 143 may include a fold line 161, which is the crease, bend, or area at which the opposing edges 143 are continuous with the remainder of the additive bottom wall 37. The opposing edges 143 also may include a first opposing edge 142 and a second opposing edge 144. The embodiment illustrated in FIG. 14D-FIG. 14E, the first opposing edge 142 includes a first opposing edge first border 146A, a first opposing edge second border 147A, and a first opposing edge third border 148A. Similarly, the second opposing edge 144 includes a second opposing edge first border 146B, a second opposing edge second border 147B, and a second opposing edge third border 148B.

Certain embodiments of an additive patterned area 141 also include one or more additive bottom wall borders 149, which may be the border between the additive patterned area 141 and the remainder of the additive bottom wall 37. The embodiment shown in FIG. 14E includes a first additive bottom wall border 149A and a second additive bottom wall border 1498.

Certain embodiments of an additive patterned area 141 may include tear guards 150 which are configured to impede the additive patterned area 141 from tearing further than intended upon opening of the additive patterned area 141. A tear guard 150 may include, for example, a material that is more difficult to tear than the surrounding material, an incision shaped differently than the remainder of the additive patterned area 141, or any other component known in the art for this purpose.

As illustrated in FIG. 14C and FIG. 14F, embodiments of a closure component 101 may include an overflow trough 103 sized and shaped to retain any additive substance 22 that may overflow onto the upper surface 101A of the closure component 101. In certain embodiments, an overflow trough 103 may include a ridge trough wall, which is configured to maximize the storage space of overflowed additive substance 22.

Certain embodiments of closure components 101 also include an attachment element 105 configured to permit attachment of the closure component 101 to another part of the system 25. In the embodiment illustrated in FIG. 14C, FIG. 14F, and FIG. 14G, the attachment element 105 is configured to permit attachment of the closure component 101 to the additive vessel 31 and the receiving vessel 71 simultaneously and permit attachment of the closure component 101 to the additive vessel 31 or to the receiving vessel 71 separately.

In certain embodiments, the attachment component 105 includes a vessel securing arrangement 106, which may be positioned to form the outer circumference 101C of the closure component 101. Embodiments of the vessel securing arrangement 106 may include a vessel securing arrangement outer circumference 106A, a vessel securing arrangement inner circumference 106B, vessel securing arrangement upper boundary 106C, one or more nodes 107, and a holding area 109.

Embodiments of a node 107 may include an upper node side 107A and a lower node side 107B. Embodiments having more than one node 107 may include outer nodes 107C, which may be positioned at or near the vessel securing arrangement outer circumference 106A, and inner nodes 107D, which may be positioned at or near the vessel securing arrangement inner circumference 106B. In the embodiment illustrated in FIG. 14F and FIG. 14G, each outer node 107C is paired with and positioned generally across from an inner node 107D. In other embodiments, nodes 107 may include other configurations such as alternating an outer node 107C with an inner node 107D, a continuous outer node 107C, or a continuous inner node 107D, to name a few. The space between each outer node 107C and each inner node 107D is termed the “internodal space” 111 for purposes of this application.

Embodiments of the vessel securing arrangement 106 may be configured to permit or may be made of a material to permit some portion of a vessel wall 33, 73 to pass through the internodal space 111 and enter the holding area 109. Certain embodiments of a vessel securing arrangement 106 also are configured to permit or are made of a material to permit the maintenance or removal of a vessel wall 33, 73 from the holding area 109. In certain embodiments, the nodes 107 are configured to permit a portion of a vessel wall 33, 73 to enter the holding area 109, to facilitate maintaining a portion of the vessel wall 33, 73 in the holding area 109, and to permit removal of the portion of the vessel wall 33, 73 from the holding area 109.

The holding area 109 is the space between the upper node side 107A and the vessel securing arrangement upper boundary 106C. The holding area 109 is sized and shaped to hold a portion of the additive wall 33, a portion of the receiving wall 73, or a portion of both the additive wall 33 and the receiving wall 73 at the same time. In certain embodiments, a holding area 109 may be configured to hold, for example, an additive top wall 34 and a receiving top wall 74, an additive side wall 35 and a receiving side wall 75, an additive top wall 34, or a receiving top wall 74, to name a few.

Embodiments of the system 25 of the present invention may be formed from materials that permit some or all of the components to be discarded and/or recycled largely after a single use and sold in the retail trade for one-time consumption. Embodiments of the system 25 also may be formed from materials that are intended to be more permanent and that permit one or both of the vessels 31, 71 to be reused. Such an embodiment is more useful for the service of food and beverage in restaurants, institutions, or in the homes of consumers. Alternatively, embodiments of the system 25 may include vessels 31, 71, each of which is made from different materials.

The additive vessel 31 also may be made of material configured to be consumed by the consumer with the additive substance 22 or receiving substance 23. Certain embodiments of an additive vessel 31 may dissolve or melt such as with contact with the moisture or steam from the liquid in the receiving vessel 71 or upon exposure of the additive vessel 31 to a treatment such as heating, cooling, microwaving, or simple exposure to ambient conditions. One simple embodiment of such an additive vessel 31 can be formed from sugar. Simple exposure to the liquid in the additive vessel 31, or steam, moisture, or the liquid in the receiving vessel 71 may cause it to dissolve, thereby adding additive substance 22 to the receiving substance 23.

Additionally, when an additive vessel 31 is nested 91 within the receiving vessel 71, the additive substance 22 or the receiving substance 23 may be thereby treated. For example, if a receiving substance 23 is warm, the heat or steam generated therefrom may heat the additive substance 22. If the additive substance 22 is milk or honey, the milk is warmed or the honey becomes less viscous—as many consumers prefer it before adding it into tea or other beverage—that may be retained in the receiving vessel 71. Also, if the additive vessel 31 includes, for example, ice, the cooled additive vessel 31 may transfer the cool temperature to the receiving vessel 71 thereby keeping the receiving substance 23 cool without the effect of melted ice diluting the receiving substance 23. In other embodiments, the additive substance 22 and the receiving substance 23 may be the same substance in different physical states. For example, the additive substance 23 may be ice, while the receiving substance 23 is water.

Embodiments of the present invention also include methods for retaining one or more substances 22, 23 in a separated condition for subsequent mixing. Embodiments of this method may include steps such as creating a system that permits mixing an additive substance with a receiving substance by positioning an additive vessel, which is configured to retain an additive substance, relative to a receiving vessel, which is configured to retain an additive substance, such that an additive substance may be released from the additive vessel and into the receiving vessel, thereby affecting the physical characteristics of the receiving substance.

Embodiments of this method also may include steps such as placing an additive substance 22 into an additive vessel 31 having an additive wall 33, which typically includes an additive patterned area 141. Then, a consumer puts a receiving substance 23 into a receiving vessel 71 and nests the additive vessel 31 in the receiving vessel 71. In addition, the consumer also may align and position a closure component 101 having a closure patterned area 151 with an additive vessel to achieve a desired alignment using alignment components 160. Then, the consumer may open an additive patterned area 141 and closure patterned area 151 with a user access tool 198 such that any substance 22 in the additive vessel 31 may pass through the additive patterned area 141 in a controlled manner.

It will be understood that the embodiments of the present invention, which have been described, are illustrative of some of the applications of the principles of the present invention. Numerous modifications may be made by those skilled in the art without departing from the true spirit and scope of the invention.

What is claimed is:

1. A system for retaining one or more substances, comprising:
an additive vessel comprised of an additive wall including an additive top wall, an additive side wall, and an additive bottom wall, collectively forming an additive inner volume by which an additive substance may be retained, said additive bottom wall configured to permit controlled release of the additive substance and including a passive control element and an additive control element;
a receiving vessel comprised of a receiving wall including a receiving top wall, a receiving side wall, and a receiving bottom wall, collectively forming a receiving inner volume by which a receiving substance may be retained, said receiving wall sized and shaped to support said additive vessel in a nested position;
wherein an additive vessel in a nested position is positioned to permit controlled release of the additive substance into the receiving substance.

2. The system of claim 1, wherein said active control element is an additive patterned area.

3. The system of claim 2, wherein said additive patterned area includes opposing edges having a first opposing edge and a second opposing edge, wherein, when said opposing edges are in a closed state, entirety of said first opposing edge is in contact with either the second opposing edge or another portion of the additive bottom wall and entirety of said second opposing edge is in contact with either said first opposing edge or another portion of the additive bottom wall, and when said opposing edges are in an open state, at least a portion of said first opposing edge is not in contact with any portion of said second opposing edge or any portion of said additive bottom wall.

4. The system of claim 3, wherein, when in the open state, said opposing edges generally define one or more open sections configured to permit controlled release of the additive substance from said additive vessel.

5. The system of claim 3, wherein said first opposing edge includes a first opposing edge first border, a first opposing edge second border, and a first opposing edge third border, and said second opposing edge includes a second opposing edge first border, a second opposing edge second border, and a second opposing edge third border.

6. The system of claim 3, wherein said additive patterned area further includes a fold line by which said opposing edges are continuous with the remainder of said additive bottom wall.

7. The system of claim 2, wherein said additive patterned area includes one or more additive bottom wall borders.

8. The system of claim 2, wherein said additive patterned area further includes tear guards.

9. The system of claim 1, wherein said passive control element includes at least one surface from the following list: a generally vertical surface, a generally horizontal surface, a generally linear surface, a generally sloped surface, a generally curved surface, a generally horizontal linear surface, a generally vertical linear surface, a generally horizontal curved surface, a generally vertical curved surface, a generally sloped linear surface, or a generally sloped curved surface.

10. The system of claim 9, wherein said additive bottom wall includes surfaces configured to form a compartment.

11. The system of claim 9, wherein said additive bottom wall includes surfaces configured to form a funnel.

12. The system of claim 1, further comprised of a closure component sized and shaped to cover said receiving vessel and said additive vessel simultaneously.

13. The system of claim 12, wherein said closure component includes a closure patterned area.

14. The system of claim 13, wherein said closure component includes a first alignment component, said additive vessel includes a second alignment component, and said active control element is an additive patterned area, wherein said first alignment component and said second alignment component are complementary components that facilitate alignment of said closure patterned area and said additive patterned area.

15. The system of claim 12, wherein said closure component includes a vessel securing arrangement, said vessel securing arrangement including at least one or more nodes and a holding area.

16. The system of claim 1, wherein said receiving vessel further includes a gripping component.

17. The system of claim 1, wherein said receiving vessel further includes a handle and a receiving spout.

18. A method for retaining one or more substances comprising at least the step of creating a system that permits mixing an additive substance with a receiving substance by positioning an additive vessel configured to retain an additive substance relative to a receiving vessel configured to retain an additive substance such that an additive substance may be released from the additive vessel and into the receiving vessel, thereby affecting the physical characteristics of the receiving substance, wherein said additive vessel is comprised of an additive side wall, an additive top wall, and an additive bottom wall including an additive patterned area, and said receiving vessel is comprised of a receiving side wall, a receiving top wall, and a receiving bottom wall.

19. A method of claim 18, additionally comprising the steps of:
aligning a closure component having a closure patterned area with an additive vessel to achieve a desired alignment;
positioning a closure component on the additive vessel in the desired alignment; and

20. A method of claim 18, additionally comprising the step of opening an additive patterned area and closure patterned area with a user access tool such that the additive substance may pass through the additive patterned area in a controlled manner.
